(19) United States
(12) Patent Application Publication
(10) Pub. No.: US 2026/0175723 A1
(43) Pub. Date: Jun. 25, 2026

(54) ACCESSIBLE ELECTRIC VEHICLE CHARGER

(71) Applicant: ALBRIGHT PRODUCT DESIGN LIMITED, Cheltenham, Gloucestershire (GB)

(72) Inventor: Alex Lee, Cheltenham, Gloucestershire (GB)

(21) Appl. No.: 19/128,779

(22) PCT Filed: Nov. 13, 2023
(86) PCT No.: PCT/GB2023/052964

§ 371 Date: May 9, 2025

(30) Foreign Application Priority Data
Nov. 11, 2022 (GB) 2216896.7

(51) Int. Cl. B60L 53/30; B60L 53/16; B60L 53/18; B60L 53/65; B60L 53/66; B65H 75/44

(52) U.S. Cl. CPC B60L 53/30; B60L 53/16; B60L 53/18; B60L 53/65; B60L 53/665; B65H 75/4471; B65H 75/4484; B65H 75/4486

(57) ABSTRACT

An electric vehicle charger has a cable and charging plug substantially hidden inside, and protected by, a housing in a stowed configuration. The charger is activated to charge a vehicle by means of a first control input, which may be for example a touchless capacitive sensor on the housing. In response to the first control input, a motorised dispensing apparatus dispenses the charging plug into a ready-to-deploy configuration, in which the charging plug on a short length of cable 18 is outside the housing. The charging plug in this position is easily graspable by a user, and can then be further dispensed into a deployed position for charging a vehicle.

The present invention relates to an electric vehicle charger.

### BACKGROUND TO THE INVENTION

Electric vehicle chargers are provided in public places, for example, car parks at service stations and supermarkets. Chargers are also commonly installed in private locations, for example on driveways and in garages.

Some chargers include a socket for receiving a plug of a charger cable, which has to be stored separately. To use this kind of charger away from home a driver will need to carry a charging cable with them in the vehicle. Where one of these chargers is installed at a driver's home, they may leave the cable close to the charger. However, it is not ideal to leave the cable plugged into the charger since it will be exposed to damage, weather, and possible theft. Using this kind of charger therefore involves getting the charging cable from wherever it is stored, and then plugging it in at both ends.

Some electric vehicle chargers, especially chargers in public places, include a charging cable permanently attached to the charger. This means that a driver does not need to carry a charging cable with them. However, such cables (which contain valuable copper) are vulnerable to theft and vandalism. They are also exposed to weather and may be inadvertently damaged. When not in use, the cable attached to the charger can be stowed in various ways, preferably with the plug within easy reach. However, users cannot always be relied on to return the cable to its correct stowage position for the next user and so plugs can be left hanging or on the ground. Although having to pick the plug up from the ground may be a minor inconvenience to many users, for users with some disabilities it can make the charger impossible to use without assistance.

Even when charging stations are used correctly, the charging cables can be heavy and difficult to handle, especially for those with disabilities. In the stowed position charging plugs are sometimes difficult to reach, and it may be difficult for some users to return the plug to that position after use. A disabled user who drops the plug on the ground by mistake may not be able to pick it up again, and then they will not be able to use the charger without assistance.

It is an object of the invention to solve these problems. In particular it is an object of the invention to provide an electric vehicle charger which protects the cable and plug, and which is easy to use, including for those with physical disabilities.

### STATEMENT OF INVENTION

According to the present invention there is provided an electric vehicle charger, the charger including:
a housing;
a charging cable having a charging plug for connection to an electric vehicle; and
motorised charging cable dispensing apparatus, the charger having a stowed configuration in which the charging plug is at least partly surrounded by the housing, a ready-to-deploy configuration in which the charging plug on a short length of charging cable is outside the housing, and a deployed configuration
in which the charging plug on a longer length of charging cable extends from the housing for allowing the charging plug to be connected to the vehicle, in which a first control input is provided, the charger being adapted to activate the cable dispensing apparatus to dispense the charging plug into the ready-to-deploy configuration in response to the first control input.

Advantageously, the charging plug in the stowed configuration is at least partially surrounded by the housing. Preferably, substantially the whole of the charging plug is enclosed or covered by the housing in the stowed configuration. This protects it from damage and may also deter and prevent cable theft, since it may not be visually obvious that the charger is of the type which includes a cable. It also presents a neat and tidy appearance which may be advantageous, particularly when consumers are choosing a product to install at home.

The first control input may be, for example, a button or non-contact sensor on the side of the housing. Alternatively, the first control input may be remote from the housing, for example on a handheld remote control or via an app on a smartphone. On activating the first control input, the charging plug is dispensed from the housing on a short length of cable, where it can readily be grasped by a user. In the ready-to-deploy position, enough of the charging plug needs to protrude outside the housing for it to be readily graspable. In some embodiments, the charging plug and a short length of charging cable are exposed outside the housing in this configuration.

The first control input may be linked to a payment means, for example a credit/debit card reader. In embodiments designed to be used in public places, a user may need to present (or insert or swipe) their payment card to pay for the charge, and in response to this the plug is dispensed from the housing into the ready-to-deploy configuration.

For embodiments designed to be installed at home, the first control input will not generally need to be linked to payment. However, a level of security may be provided by providing user identification means, for example by requiring scanning of an RFID fob, or controlling via an app which has been pre-paired with the charger, so that only authorised users can activate the control input and use the charger.

The user identification means may provide a means of authorising a user to access and/or operate the first control input. A user may be an authorised user if they have made a payment or are otherwise registered as authorised to use the charger.

The user identification means may include a biometric authentication means. The biometric authentication means may include fingerprint, voice and/or facial recognition, for example.

A vehicle may be considered to be a user, in which case the user identification means may include number plate recognition.

In some embodiments, the first control input may be a capacitive touch sensor, comprising a conductive pad on an inside of an insulating cover of the housing. A capacitive touch sensor provides for a very robust switch and allows for a completely sealed weathertight cover. The pad may be made quite large, for example around the size of a typical person's palm, or at least around 25 cm² in area. By touching the outside of the charger housing in the region of the pad, the charger may be activated to dispense the cable into a ready-to-deploy configuration.

Other alternative types of control input include non-contact proximity sensors such as infra-red reflective proximity sensors. Providing a control which can be activated easily by a touch or a hand wave allows for a fully sealed housing cover, and an easy to use device.

As an alternative to providing the first control input on the housing of the charger, a handheld remote device may be provided. For example, a small remote control on a keyfob, similar to a garage door opener, may be used as the first control input. A further possibility is to use an app on a user's smartphone. This may be particularly useful for example for wheelchair users who may not be able to reach a charger installed at an ordinary standing height. However, by using the handheld remote device to activate the charger, enough cable may be dispensed to allow the wheelchair user to reach the charging plug.

Once the user has the charging plug in his or her hands, the cable can be further extended into the deployed configuration as will be described in further detail below.

In some embodiments, the length of cable dispensed in the ready-to-deploy position may be dependent on a signal sent on the first control input. This may be advantageous for providing a charger which can be used by different users with different needs. For example, the charger could be mounted in a position just above the height of an average standing person's hands when they reach out to grasp the plug. The standing person (who may have difficulty bending down, for example) may require a short length of cable to be dispensed, just enough to expose the plug from the housing so that it can be grasped. However, a wheelchair user may require the plug to be dispensed on a longer length of cable in the ready-to-deploy position, so that the plug can be easily reached and grasped from a sitting position in a wheelchair. This can be achieved for example with multiple different RFID cards issued to different users, or different user profiles where the first control input is via a smartphone app, or simply different switches on the housing of the charger.

Once the user has the charging plug in their hands, they will want to further dispense the cable from the housing into the deployed configuration, so that they can charge up their electric vehicle. In some embodiments, this may be achieved manually simply by pulling the cable, which may then for example uncoil from a reel within the housing. However, more preferably, the motorised cable dispensing apparatus can dispense the cable from the ready-to-deploy configuration to the deployed configuration.

Preferably, a second control input is provided for activating the dispensing apparatus to dispense the cable from the ready-to-deploy configuration to the deployed configuration. The second control input may be provided by a switch, button, or other operating means provided on the charging plug. Thus the first control input can be used to expose the charging plug in the ready-to-deploy position. The user then grasps the charging plug and uses the second control input, located on the charging plug itself, to control further dispensing of the cable into the deployed configuration.

In such embodiments, the second control input on the charging plug may be concealed and/or inaccessible when the charging plug is in the stowed configuration.

For example, the second control input be fully enclosed in the charger housing in the stowed configuration. The second control input may only be exposed and accessible on operation of the first control input.

The housing may include a door. The second control input may be provided behind the door in the housing when in the stowed configuration. The door may open on operation of the first control input.

The second control input may be exposed and accessible with the charging plug in the ready-to-deploy configuration. In some embodiments, irrespective of whether it would be difficult or impossible to access the second control input in the stowed position, the second control input may be in any case disabled. This will prevent someone for example from reaching inside the housing, including with a tool, to operate the second control input for example when they have not paid to use the charger or are not an authorised user who has operated the first control input.

Preferably, the second control input allows incremental control of the cable dispensing apparatus into a configuration in which any length of cable is dispensed out of the housing. In the simplest case, this could simply include a button which dispenses the cable while the button is held down, and stops dispensing when the button is released.

Providing a second control input, and preferably allowing incremental control, allows a user, particularly a disabled user, to more easily control dispensing of the cable and movement of the charging plug to where they need it to be, i.e. adjacent the charging point on the vehicle so that charging can commence. Only a required length of cable needs to be dispensed, depending on where the vehicle is parked and the position of the charging socket on the vehicle in relation to the charger. This avoids unnecessarily long lengths of cable trailing and creating a trip hazard.

Preferably the charger further includes motorised cable retracting apparatus. In one embodiment, this may be provided as combined motorised cable dispensing and retracting apparatus, e.g. a reversible motor or a suitable transmission so that the motor can turn a reel in either direction to either dispense or retract the cable.

The cable retracting apparatus may be activated to retract the cable back into the stowed position by means of a signal at a control input. The retracting function may be usefully activated either at the first control input, for example on the body of the charger housing or via a smartphone app, or at the second control input, for example a switch or button on the charger plug. In normal use, when the user has finished charging their vehicle they will unplug the charger plug from the vehicle. A retraction switch on the charging plug itself is therefore very convenient. However, it is also useful to be able to activate the retraction function when the charging plug is out of reach, for example because it has been dropped on the ground by mistake and the user is unable to bend down to pick it up. Activating the retraction function by a switch or other control on the charger housing, and/or via a smartphone app or remote control, will allow the plug to be returned to the stowed condition from where the user can then start the process again. Advantageously, a control may be provided to retract the cable to the ready-to-deploy configuration rather than the stowed condition, so that the charger plug can be grasped again and then deployed to charge the vehicle.

As with the dispensing control, the retraction signal may usefully allow for incremental retraction, for example the retraction switch may retract the cable while it is held down, and stop retracting when it is released. This allows the user to control the retraction process so that they are able to keep hold of the charger plug, and avoid it dropping on the ground where it may be damaged.

However, once there is less than a predetermined amount of cable extending out of the housing, for example less than about 30 cm (1 foot), embodiments may automatically continue retracting the cable into the housing until the cable is fully in the stowed configuration. This is because it may be difficult or even impossible to continue to hold down a retraction switch which is positioned on the charging plug, since the charging plug is substantially enclosed within the housing when fully retracted.

In some embodiments, the cable dispensing from the ready-to-deploy to the deployed position may be provided as a power-assist mechanism. To put it another way, the second control input may be provided by means to detect when the cable is being pulled out of the housing. In these embodiments, the user can pull the charging plug out of the housing with a light force. In response to the user's pulling force, the motorised dispensing apparatus activates to assist with dispensing the cable. In some embodiments, the motorised dispensing apparatus may then continue to dispense the cable until it is in the fully-deployed configuration, since it will generally be difficult for the user to continue to pull once there is a certain amount of cable dispensed.

The electric vehicle charger may be part of a charging post. The electric vehicle charger may be mounted on a wall. The electric vehicle charger may be installed approximately 70 cm to 120 cm from the ground. In the stowed configuration, the charger plug may be disposed 70 cm to 120 cm from the ground. The electric vehicle charger may not be an overhead electric vehicle charger.

### BRIEF DESCRIPTION OF THE DRAWINGS

For a better understanding of the present invention, and to show more clearly how it may be carried into effect, reference will now be made by way of example only to the accompanying drawings, in which:

FIG. 1 shows a perspective cutaway view of a charger according to the invention;

FIG. 2 shows a perspective view of the charger of FIG. 1, fully assembled, and in a stowed configuration;

FIG. 3 shows a perspective view of the charger of FIG. 1, fully assembled, and in a ready-to-deploy configuration;

FIG. 4 shows a perspective view of the charger of FIG. 1, fully assembled, and in a deployed configuration; and

FIG. 5 shows an exploded view of a housing cover with a capacitive touch sensor, part of the charger of FIG. 1.

### DESCRIPTION OF PREFERRED EMBODIMENTS

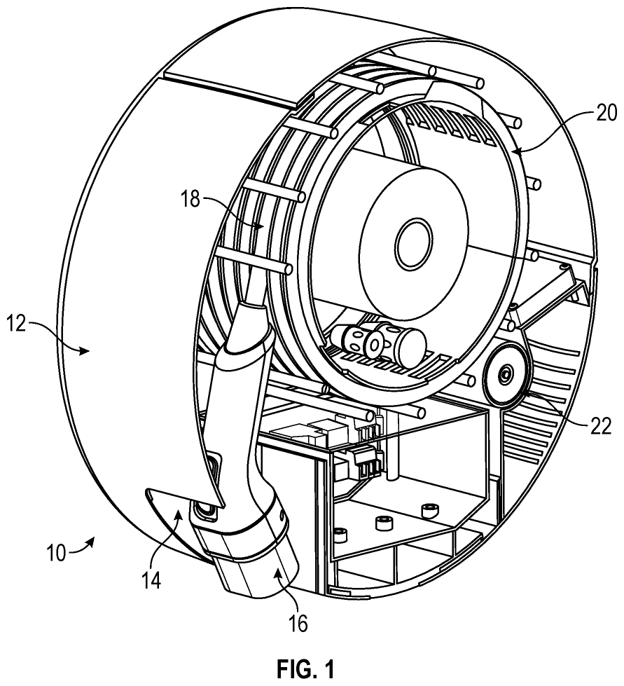

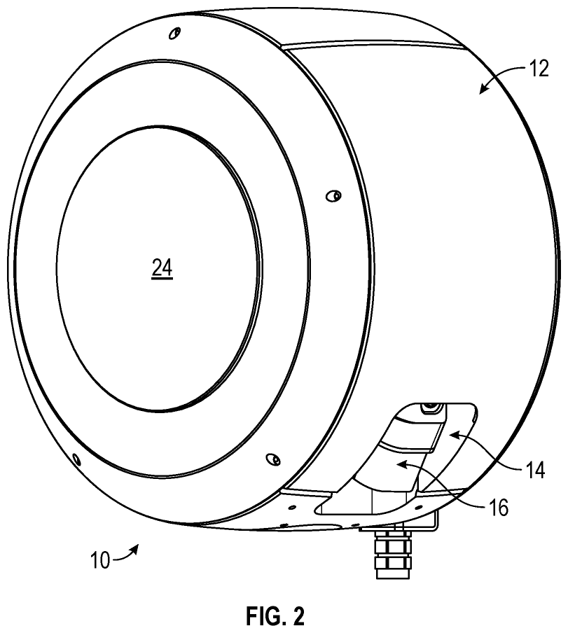

Referring firstly to FIG. 1, an electric vehicle charger is indicated generally at 10. In FIG. 1 the charger is shown with part of the housing cut away, or removed, so that the internals of the charger are visible. The charger is shown fully-assembled, i.e. with all external housing components in place, in FIG. 2.

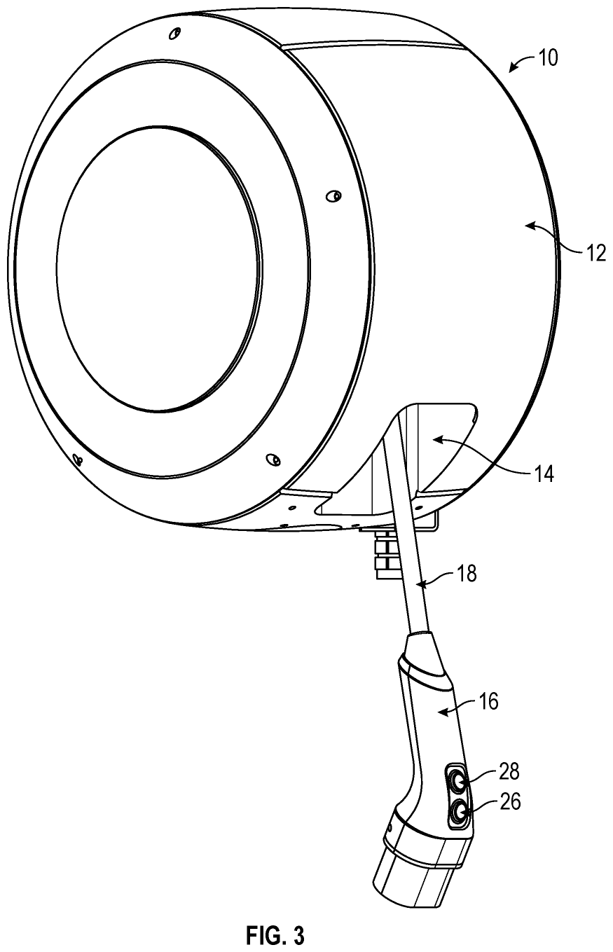

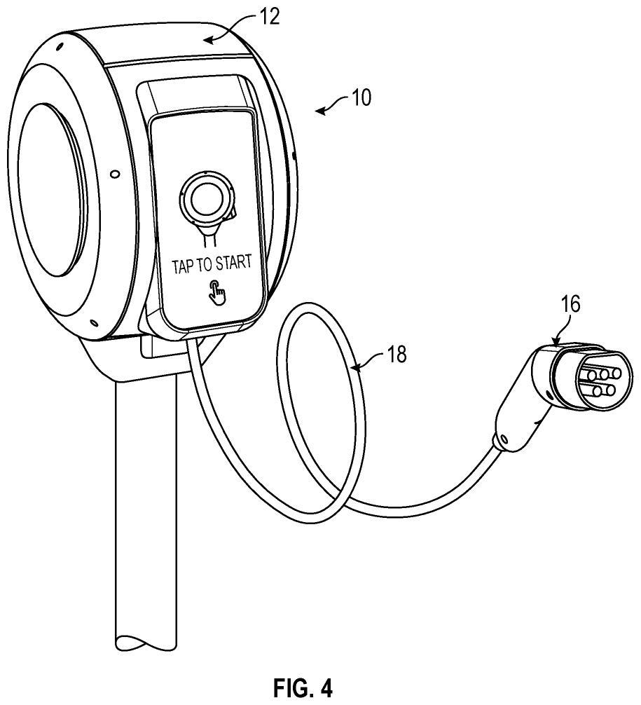

The charger 10 includes a housing 12. The housing 12 provides protection for the components of the charger 10 from weather, accidental and even deliberate damage. An aperture 14 in the housing provides an entrance/exit so that a charging plug 16 can be stowed substantially within the housing 12, enclosed and protected by the housing 12 as shown in FIG. 1 and FIG. 2, or be deployed outside the housing 12 as shown in FIG. 3 and FIG. 4.

The charging plug 16 is provided on a charging cable 18. The cable 18 is shown in FIG. 1 retracted onto a reel 20. The reel can be turned by motor 22 to dispense or retract the cable 18. By driving the motor 22 in one direction the cable 18 is dispensed, and by driving the motor in the other direction the cable is retracted.

The reel arrangement, which allows for dispensing and retraction of the cable 18, controlled entirely by the motor 22, with little possibility of jamming, is described in more detail in the applicant's co-pending British patent application no. 2203016.7.

As seen in FIG. 1, the entire cable 18 and most of the charging plug 16 is enclosed within the housing 12 in the stowed configuration. Although there is an aperture 14 in the housing 12, the aperture is preferably downwards-facing and so water ingress is prevented. Although a small part of the charging plug 16 may protrude through the aperture, most of the charging plug is enclosed and covered by the housing 12. It is protected from damage. The charging plug 16 is also not readily visible and therefore it is not immediately obvious that the charger 10 is of the type which includes a permanently attached cable. This may deter thieves. The charging plug 16 in any case will be difficult to remove when it is in the stowed configuration. In some embodiments a locking means may be provided on the reel 20 or otherwise to prevent the cable from being manually pulled out, even if it can be grasped through the aperture 14 which will be difficult since the plug 16 is substantially enclosed by the housing 12.

With reference to FIG. 2, a user wishing to use the charger to charge their vehicle will need to operate the first control input. In this embodiment, the first control input is provided by a capacitive sensor which detects a user's hand touching or in proximity to an outside flat surface 24 of the housing 12. By touching, or even just bringing his hand close to, the surface 24 of the housing, the user activates the first control input. In response to this, the charger activates. The motor 22 operates to rotate the reel 20, and dispense a short length of cable. This puts the charger in a ready-to-deploy configuration, as shown in FIG. 3. The length of cable dispensed in this configuration may be for example about 30 cm (12 inches) or less. The purpose is simply to extend the charging plug 16, or at least a part of the charging plug 16, outside of the housing so that it can easily be grasped by a user. In particular the charging plug 16 is exposed enough so that the control buttons 26, 28 can be accessed and operated. In some embodiments, no actual cable will be exposed outside the housing, but only enough of the plug 16 that it can be easily gripped.

In some embodiments the length of cable dispensed in the ready-to-deploy configuration may be determined according to a signal on the first control input. For example, instead of a capacitive sensor, an RFID card may be scanned. Different users may be given different RFID cards, and so the charger can dispense an amount of cable according to the particular user's needs. For example, a user who is ambulant may find it most convenient if the charging plug 16 is only dispensed a short way out of the housing, so that it can be grasped easily from a standing position without bending down. However a wheelchair user may require the charging plug 16 to be dispensed on a slightly longer length of cable so that it may be grasped from a sitting position in a wheelchair.

The first control input may in some embodiments be provided via a smartphone app or other remote control. This too provides a way to distinguish between different users.

In some embodiments the first control input may be linked to a payment system. For example a user may swipe, insert or present their payment card in order to pay for a charge, in response to which the charger is activated into the ready-to-deploy configuration. Payment for public charging, and corresponding activation of chargers, may also be controlled through a smartphone app. A payment card also identifies a user and could be linked to a user's profile so that an amount of cable is dispensed according to the user's needs.

In other embodiments, a user identification means may be provided. The user identification means may provide a means of authorising a user to access and/or operate the first control input. A user may be an authorised user if they have made a payment or are otherwise registered as authorised to use the charger 10.

The user identification means may include biometric authentication. The biometric authentication may include fingerprint, voice and/or facial recognition, for example.

A vehicle may be considered to be a user, in which case the user identification means may include number plate recognition.

Once the charging plug 16 is dispensed out of the housing 12, as shown in FIG. 3, it can be grasped in the user's hands. A second control input in the form of buttons 26, 28 is provided on the charging plug 16 to control further dispensing of the cable 18 to put the charger into a fully-deployed configuration, as shown in FIG. 4. In this embodiment, holding down button 26 causes the motor 22 to rotate in one direction, to further dispense the cable 18, and holding down button 28 causes the motor 22 to rotate in the other direction, to retract the cable 18.

When either button 26, 28 is released, the motor 22 stops.

The user can therefore use the buttons 26, 28 to dispense as much cable as is necessary, and at whatever speed is convenient bearing in mind that the user may need to manoeuvre the plug 16 into position, to plug in and charge his or her vehicle.

Other examples of plug-mounted controls which may be suitable for use with the current invention are described in the applicant's co-pending British application no. 2201545.7.

When charging is finished, the user can unplug the plug 16 from the vehicle, and use button 28 to retract the cable. Again, the motor 22 rotates in this embodiment only while the button is being held down, and so the user can control the retraction at whatever speed they need in order to safely manoeuvre the plug 16 back towards the housing 12, avoiding any damage.

Once a predetermined amount of cable has been retracted back into the housing, for example so that less than about 30 cm (1 foot) of cable extends outside the housing, the motor may continue to rotate to fully retract the cable into the stowed configuration, irrespective of whether button 28 is being held down.

Additionally a further control may be provided, for example via a smartphone app, remote control, or simply a switch on the housing, for retracting the cable in the event that the plug 16 cannot be reached, for example because the plug has been dropped on the ground by mistake.

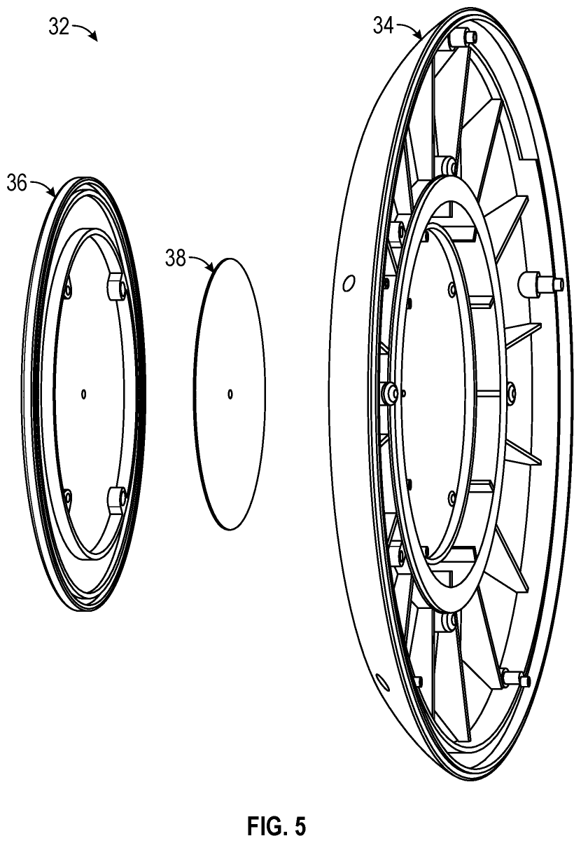

Referring to FIG. 5, an exploded view of a housing cover 32 is shown. In this embodiment, the housing cover is provided in two parts 34, 36. A cover component 34 closes the housing and provides a weathertight seal to protect the components inside. A secondary cover 36 is provided on the outside of the cover component 34. A conductive pad 38 is sandwiched between the cover component 34 and the secondary cover 36. When fully assembled, the conductive pad 38 is on the inside of the secondary cover 36. The secondary cover 36 protects the conductive pad 38, but provides a thin wall between the conductive pad 38 and the outside of the housing. The conductive pad forms part of a capacitive touch or proximity sensor which is part of the first control input. Preferably, the conductive pad is at least around 25 cm², and can detect for example a person's hand in close proximity to the outside of the housing.

The invention provides for a convenient, accessible, and compact charger of which embodiments may be suitable both for public use (e.g. in service stations, supermarket carparks, etc.) and for private use, for example installed on the front of a house for use with a vehicle parked on a driveway. By using the charger of the invention, no charging cable has to be carried in the vehicle and yet the cable permanently attached to the charger is hidden away and protected from damage, theft and vandalism. The charger may be used easily, including by users with physical disabilities who would otherwise struggle to manoeuvre a heavy cable to charge the vehicle and then put it back in its correct stowed position afterwards.

In some embodiments, the electric vehicle charger may be part of a charging post. The electric vehicle charger may be mounted on a wall.

The charger is deployed in a two-stage process. A first control input allows the user to activate the charger to move the charging plug into a position where it can be grasped. From there, a second control input on the charging plug itself allows further dispensing of the charging cable to be easily controlled, including by users with physical disabilities.

The embodiments described above are provided by way of example only, and various changes and modifications will be apparent to persons skilled in the art without departing from the scope of the present invention as defined by the appended claims.

1-14. (canceled)

15. An electric vehicle charger including:
a housing;
a charging cable having a charging plug for connection to an electric vehicle; and
a motorised charging cable dispensing apparatus,
the charger having a stowed configuration in which the charging plug is at least partly surrounded by the housing, a ready-to-deploy configuration in which the charging plug protrudes outside the housing, and a deployed configuration in which the charging plug and the charging cable extends from the housing for allowing the charging plug to be connected to the electric vehicle,
in which a first control input is provided, the charger being adapted to activate the motorised charging cable dispensing apparatus to dispense the charging plug from the stowed configuration into the ready-to-deploy configuration in response to operation of the first control input.

16. The electric vehicle charger as claimed in claim 15, in which a second control input is provided for activating the motorised charging cable dispensing apparatus to dispense the charging cable from the ready-to-deploy configuration to the deployed configuration, in which the second control input is provided by operating means provided on the charging plug, the second control input being concealed and inaccessible when the charger is in the stowed configuration, and accessible when the charger is in the ready-to-deploy configuration.

17. The electric vehicle charger as claimed in claim 16, in which the second control input allows incremental control of the motorised charging cable dispensing apparatus to dispense cable until a chosen length of cable is dispensed out of the housing, and then stop dispensing cable.

18. The electric vehicle charger as claimed in claim 15, in which the first control input includes a user identification means for authorising a user to access and/or operate the first control input.

19. The electric vehicle charger as claimed in claim 18, in which the user identification means includes number plate recognition.

20. The electric vehicle charger as claimed in claim 18, in which the user identification means includes biometric authentication.

21. The electric vehicle charger as claimed in claim 18, in which a length of cable dispensed in the ready-to-deploy configuration is dependent on a profile associated with the user identified by the user identification means.

22. The electric vehicle charger as claimed in claim 15, in which the first control input is provided as a switch or sensor on the housing.

23. The electric vehicle charger as claimed in claim 15, in which the first control input is provided on a handheld remote device.

24. The electric vehicle charger as claimed in claim 15, in which the first control input includes payment acceptance means.

25. The electric vehicle charger as claimed in claim 15, further including a motorised cable retracting apparatus.

26. The electric vehicle charger as claimed in claim 25, in which a length of cable dispensed in the ready-to-deploy configuration is dependent on a profile associated with the user identified by a user identification means, and in which the motorised charging cable dispensing apparatus is controllable to retract the cable back into the stowed configuration by means of either the first control input or a second control input.

27. The electric vehicle charger as claimed in claim 25, in which the control input for controlling retraction of the charging cable allows incremental control of the motorised charging cable dispensing apparatus to retract cable until a chosen length of cable is exposed outside of the housing, and then stop retracting cable.

28. The electric vehicle charger as claimed in claim 27, in which the motorised charging cable dispensing apparatus will automatically continue to fully retract the cable to the stowed configuration, irrespective of user input, if an amount of cable exposed outside the housing is less than a predetermined minimum length.
